(19) United States
(12) Patent Application Publication
(10) Pub. No.: US 2007/0023254 A1
(43) Pub. Date: Feb. 1, 2007

(54) Motor vehicle clutch linkage lubrication

(76) Inventor: Muneer Abu Samra, Southern Pines, NC (US)

Correspondence Address: BRINKS HOFER GILSON & LIONE, P.O. BOX 10395, CHICAGO, IL, 60610, US

(21) Appl. No.: 11/193,189

(22) Filed: Jul. 29, 2005

(51) Int. Cl. F16D 19/00; F16D 13/00

(52) U.S. Cl. 192/98; 192/113.1

(57) ABSTRACT

Several distinct motor vehicle clutch fork and release bearing lubrication arrangements which may be utilized singly or in various combinations include: oil impregnated inserts, self-lubricating pockets, single or multiple central grease fittings in communication with passageways that provide grease to contact and bearing surfaces and sealed boots filled with lubricant which cover a portion of ends of the release fork.

### BACKGROUND OF THE INVENTION

The invention relates generally to motor vehicle clutches of the manual type and more specifically to manual motor vehicle clutches having various arrangements for providing and improving lubrication of certain components.

Both the location and operation of a manual motor vehicle clutch suggests the difficulty of its existence. A typical manual motor vehicle clutch is disposed behind the prime mover which is typically an internal combustion gas or Diesel engine and a head of the transmission. In service, it is called upon to repeatedly connect and disconnect the driving force of the engine to the transmission. Hundreds of horsepower, hundreds of foot pounds of torque, thousands of revolutions per minute and thousands of operating cycles characterize its operating environment.

Sandwiched between the prime mover and transmission of a vehicle, replacing or even servicing a manual clutch is a project to reckon with. Due to the expense of replacing the clutch, which includes not only replacement components and labor but also the down time of the vehicle, it is not surprising that significant effort has been undertaken to improve and extend the service life of the clutch. This effort has taken many forms: the constant search for improved friction materials being only one.

In a typical manual clutch, a release or throw out bearing is translated axially along the transmission input shaft by a release fork which may be coupled through a linkage to the clutch pedal or coupled through a closed hydraulic system to the clutch pedal. The release bearing removes the pressure applied to the clutch plate and thus controls engagement and disengagement of the clutch. Because the release bearing may rotate relative to the transmission input shaft and because substantial force is applied to the release biasing by the release fork, the interface between the two components as well as other release fork features such as its pivot should be consistently supplied with a lubricant such as grease. The present invention addresses this requirement.

### SUMMARY OF THE INVENTION

Several distinct motor vehicle clutch fork and release bearing lubrication arrangements which may be utilized singly or in various combinations include: oil impregnated inserts, self-lubricating pockets, single or multiple centrally disposed grease or zirc fittings in communication with passageways that provide grease to contact and bearing surfaces and flexible boots filled with lubricant which cover a portion of the ends of the release fork.

Thus it is an object of the present invention to provide various means for ensuring the consistent presence of lubrication on motor vehicle clutch components.

It is a further object of the present invention to provide lubrication to the release bearing and release fork of a manual clutch by incorporating oil impregnated inserts into the release bearing.

It is a still further object of the present invention to provide lubrication to the release bearing and release fork of a manual clutch by incorporating grease retaining circumferential grooves into the release bearing.

It is a still further object of the present invention to provide lubrication to the release fork and release bearing of a manual clutch by incorporating a lubricating arrangement including lubricant retaining grooves, passageways and a grease fitting in the release bearing.

It is a still further object of the present invention to provide lubrication to the release bearing and release fork of a manual clutch by incorporating a central lubricating arrangement including zirc fittings and passageways in the release fork.

It is a still further object of the present invention to provide lubrication to the release bearing and release fork of a manual clutch by incorporating lubricant boots on the ends of the release fork.

Further objects and advantages of the present invention will become apparent by reference to the following description of the preferred embodiment and appended drawings wherein like reference numbers refer to the same component, element or feature.

### BRIEF DESCRIPTION OF THE DRAWINGS

FIG. 1 is a side elevational view in full section of a typical manually actuated motor vehicle friction clutch;

FIG. 2 is an enlarged, fragmentary, sectional view of a release bearing including lubricating inserts according to the present invention;

FIG. 3 is an enlarged, fragmentary, sectional view of a manual clutch release bearing and fork having lubricating grooves according to the present invention;

FIG. 4 is an enlarged, fragmentary, sectional view of a manual clutch release bearing and fork having lubricating grooves, lubricant passageways and grease fittings according to the present invention;

FIG. 5 is a fragmentary, perspective view of a release bearing and release fork of a manual clutch having zirc fittings and lubricant passageways according to the present invention;

FIG. 6 is a fragmentary, perspective view of a release bearing and release fork of a manual clutch having a zirc fitting and lubricant passageways according to the present invention; and

FIG. 7 is a fragmentary, perspective view of a release bearing and release fork of a manual clutch incorporating a lubricant boot according to the present invention.

### DETAILED DESCRIPTION OF THE PREFERRED EMBODIMENT

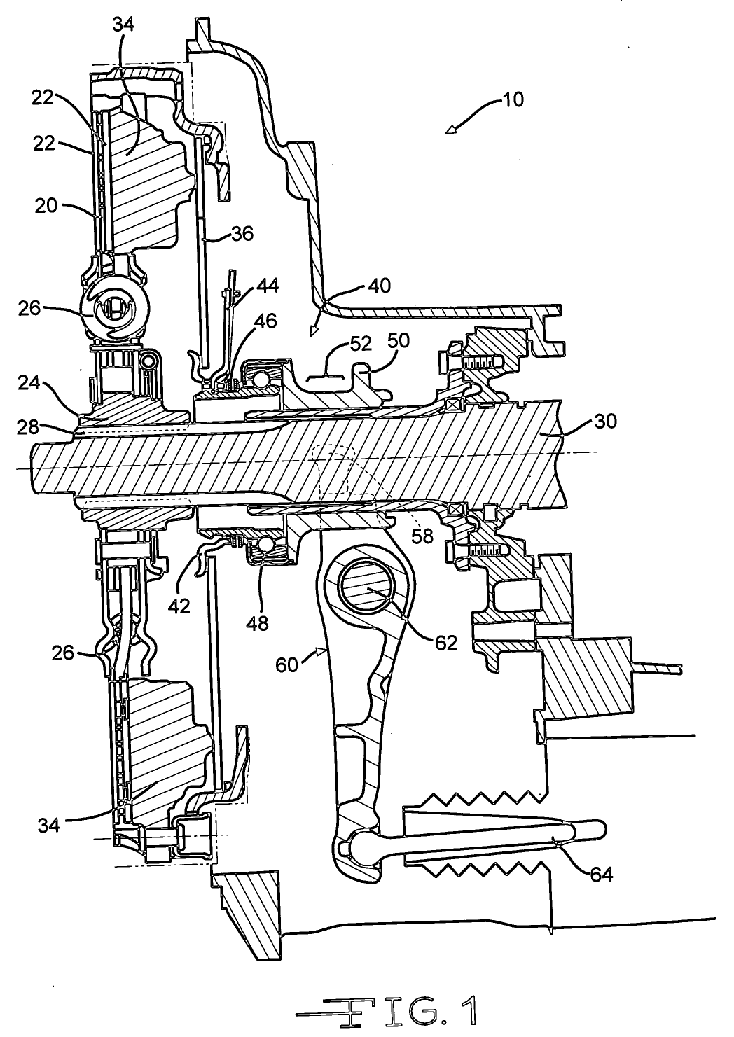

Referring now to FIG. 1, a typical, manual motor vehicle clutch, representative of many configurations and variations, is illustrated and designated by the reference number 10. The motor vehicle clutch 10 includes a circular clutch or support plate 20 having inner and outer linings and surfaces of friction material 22. The clutch plate 20 is rotationally coupled to an inner hub 24 through a plurality of torsional spring dampers 26 disposed in conventional circumferential fashion. The inner hub 24 is coupled by interengaging sets of male and female splines 28 to a transmission input shaft 30. The clutch plate 20 is disposed between a fly wheel (not illustrated) driven by a prime mover such as an internal combustion gasoline or Diesel engine and an annular pressure plate 34. The pressure plate 34 is acted upon by an annular diaphragm spring 36 which functions as a second class lever to transmit axial force to the pressure plate 34 and cause axial translation thereof upon axial translation of a clutch release bearing assembly 40. The clutch release bearing assembly 40 generally includes a circular collar 42 which engages the diaphragm spring 36, a return spring 44 which biases the clutch release bearing assembly 40 to the left as illustrated in FIG. 1, a pair of bearing assemblies 46 and 48 including a thrust bearing assembly 46 and ball bearing assembly 48 which reduce friction and allow free rotation of the clutch collar 42 relative to a release hub or bearing 50 defining a circumferential channel 52.

In turn, the circumferential channel 52 of the release hub bearing 50 is engaged by the spaced apart arms or terminal portions 58 of a release fork 60. The release fork 60 is pivotally disposed upon a transverse pivot pin 62 and functions as a first class lever. As such, the release fork 60 is acted upon by an end portion of a clutch linkage 64 which translates to the left and right, as illustrated in FIG. 1, to disengage and engage the clutch 10, respectively. It will be appreciated that the foregoing description of the clutch 10 is representative and exemplary only and is intended to generally present the components of a typical manual motor vehicle clutch and the environment within which the present invention resides.

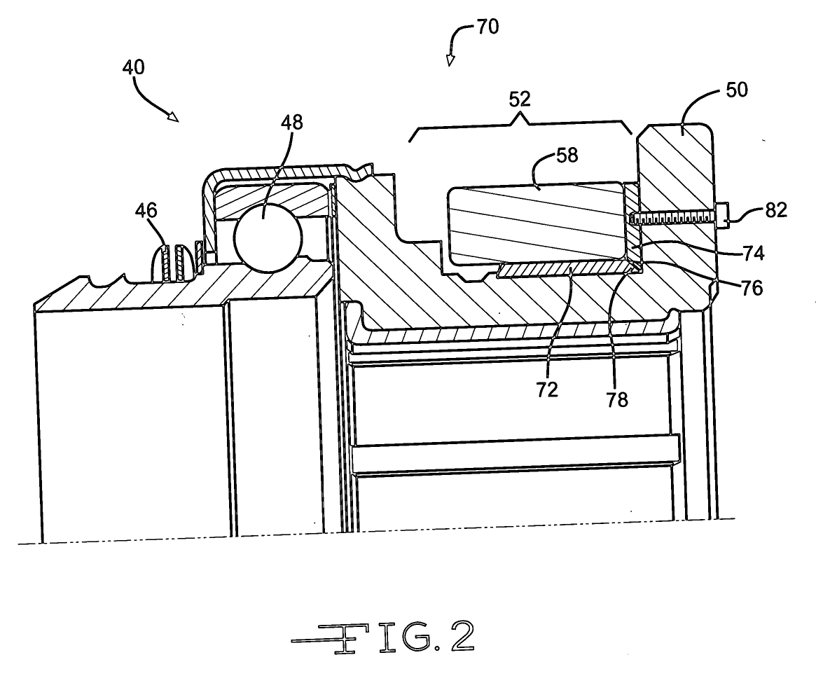

Referring now to FIG. 2, a first embodiment lubrication arrangement for the manual clutch release bearing 50 is illustrated. As noted, the release bearing 50 includes a circumferential groove or channel 52 which receives a pair of spaced apart shift arms 58 of the release fork 60, one of which is illustrated in FIG. 2. Disposed within the circumferential channel 52 of the release bearing 50 is a first cylindrical oil or grease impregnated bronze insert 72 and a second annular oil impregnated bronze insert 74 disposed at a right angle to the first oil or grease impregnated insert 72. Together, the oil or grease impregnated bronze inserts 72 and 74 fully cover the surfaces of the release hub or bearing 50 against which the release arms 58 engage. Hence, friction is reduced relative to non-oil impregnated components and the service life of both the release arms 58 and the release hub or bearing 50 are improved. The oil or grease impregnated bronze inserts 72 and 74 may be of any porous lubrication bearing structure or microstructure such as sintered metal. The oil or grease impregnated inserts 72 and 74 may be cast in place on the release bearing 50 or both may consist of two or more cylindrical or curved sections. The annular insert 74 may be configured with oblique inner edges 76 which engage complementarily configured oblique edges 78 on the cylindrical insert 72 to retain them. In turn, the annular inserts 74 are retained in the release bearing 50 by a plurality of threaded fasteners 82 which extend through the release bearing wall and into the insert 74.

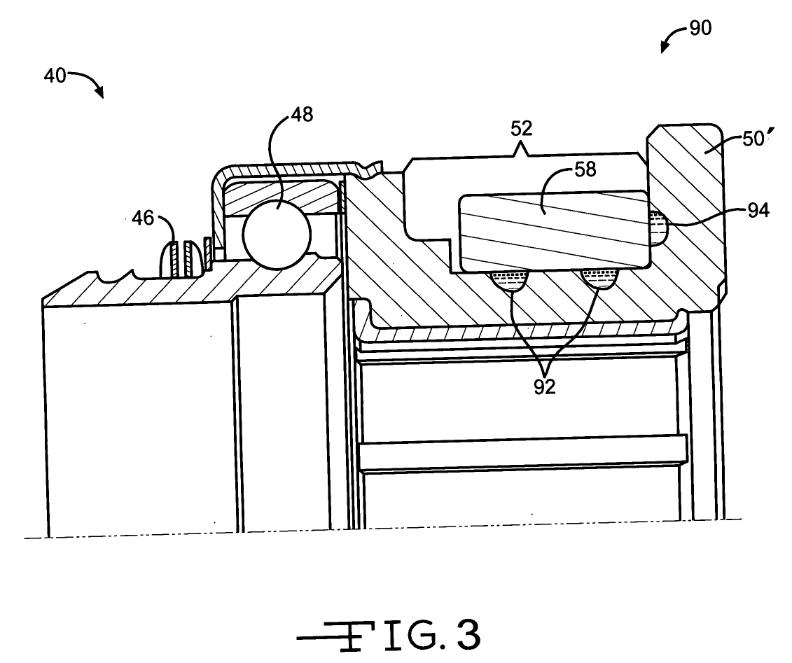

Referring now to FIG. 3, a second motor vehicle manual clutch lubrication arrangement for a release bearing 50′ is illustrated and designated by the reference number 90. Here, a plurality of circumferential grooves 92, two of which are disposed at the bottom of the circumferential groove 52 and a third groove 94 is disposed along the sidewall are filled with a heavy grease 96. The grease 96 is thus disposed exactly at the regions of contact between the release arms 58 and the release bearing 50′. In fact, as the release bearing 50′ slowly wears, such wearing will involve exposure of additional lubricant or grease 96 and thus its distribution about the circumferential groove 52.

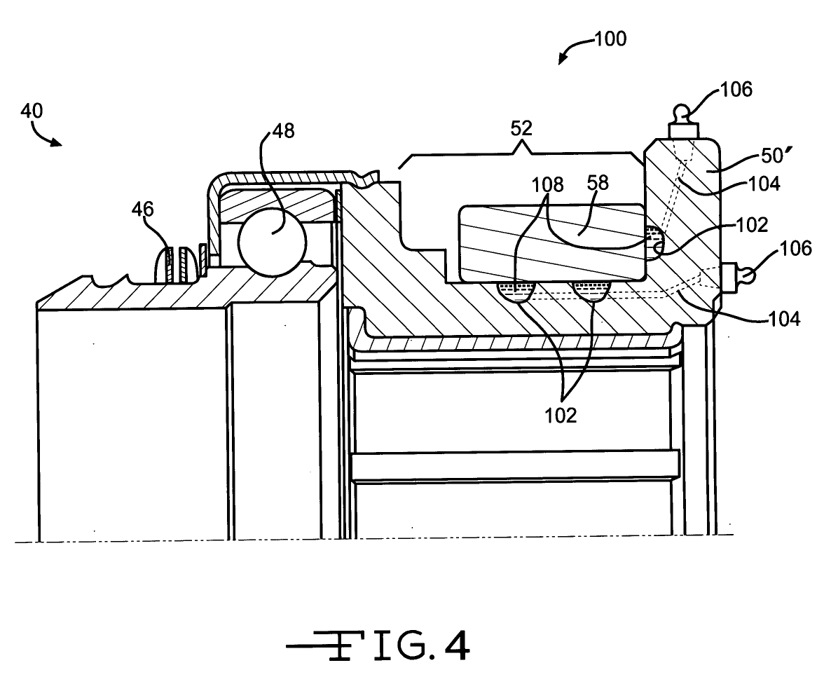

Referring now to FIG. 4, a third motor vehicle clutch lubrication arrangement for a release bearing 50″ is illustrated and designated by the reference number 100. Here, a plurality of circumferential grooves 102 are formed in the friction services of the release bearing 50″ and are in communication with one or more internal passageways 104 which terminate and communication with grease or zirc fittings 106. Although two zirc fittings 106 are illustrated, it will be appreciated that a single zirc fitting 106 and single passageway 104 may be utilized to provide grease 108 to all of the circumferential grooves 102.

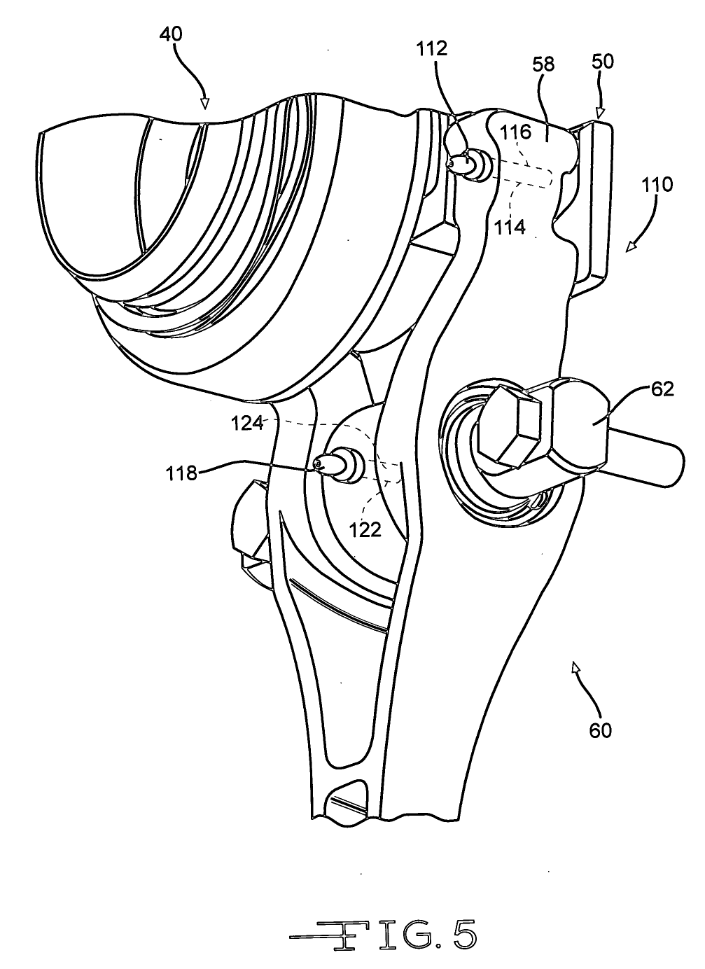

Referring now to FIG. 5, a fourth embodiment of a manual clutch release bearing lubrication arrangement is illustrated and designated by the reference number 110. Here, a pair of zirc fittings 112 each disposed proximate the end of the release fork 58, one of which is illustrated in FIG. 5, communicate with a passageway 114 which receives, stores and distributes grease 116 to the contacting and frictional features of the arms 58 of the release fork 60 and the release bearing 50. Similarly, a grease or zirc fitting 118 disposed in a central portion of the release fork 60 communicates through a passageway 122 with the release fork pivot pin 62 and provides a lubricant such as grease 124 into this region to reduce friction and improve the service life of these components.

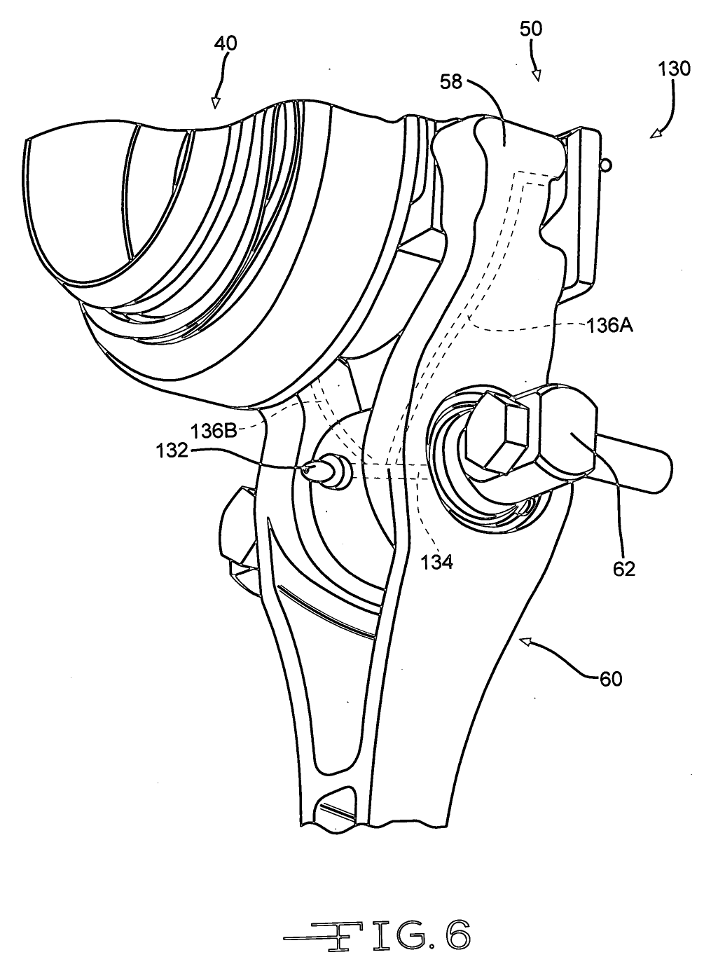

Referring now to FIG. 6, a fifth embodiment manual clutch release bearing lubrication arrangement is illustrated and designated by the reference number 130. Here, a single grease or zirc fitting 132 communicates with a plurality of passageways, a first passageway 134 communicating and providing a lubricant such as grease to the pivot pin 62 and a second pair of diverging passageways 136A and 136B which carry the lubricant to each terminal portion of the release forks 58 and provides such lubricant to the points of contact to reduce sliding friction and improve the service life of the components.

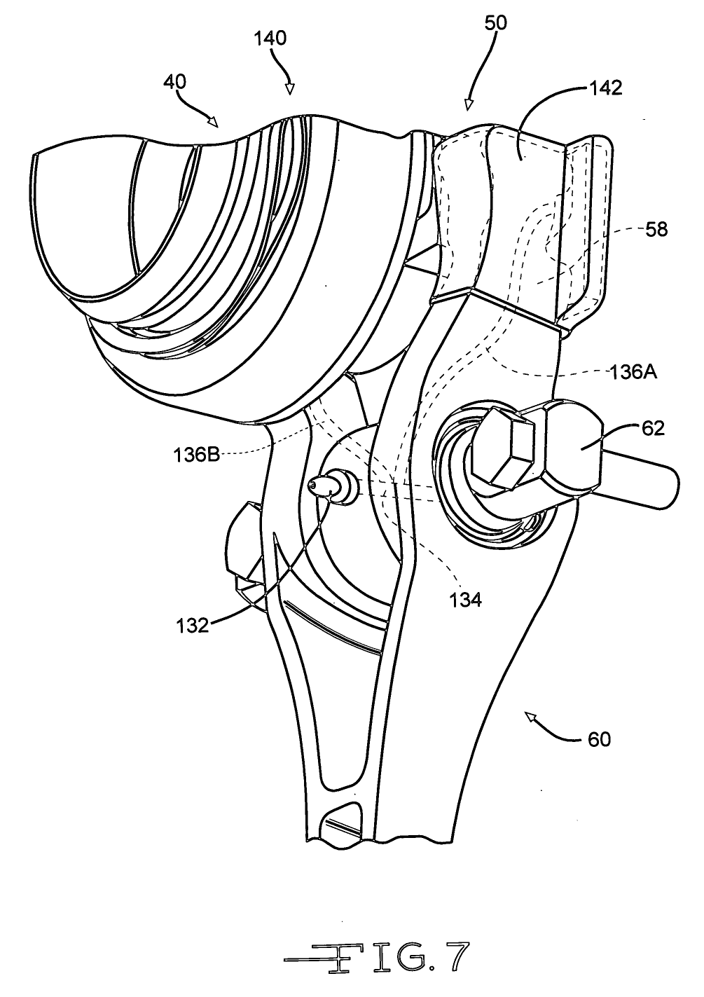

Finally, referring to FIG. 7, a sixth embodiment of a manual clutch release bearing lubrication arrangement is illustrated and designated by the reference number 140. Here, in addition to the grease or zirc fitting 132 and the passageways 134, 136A and 136B, a flexible, preferably elastomeric boot 142 is utilized over the end of each of the release arms 58 to ensure retention of the lubricant such as grease and its application to the points of contact on the friction between the release arms 58 and the release bearing 50. It will be appreciated that the composition of the flexible boot 142 be of a material such as a lubricant resistant elastomer which is compatible with and not degraded by the lubricant(s) utilized with the release fork 60 and release bearing 50.

It should be appreciated and understood that the various embodiments disclosed above may be utilized in various combinations on a release fork and bearing assembly. For example, the oil impregnated inserts 72 and 74 may be utilized with a release fork 60 having a flexible boot 142. Or, the inserts 72 and 74 may be utilized with the centralized lubrication arrangement 130 illustrated in FIG. 6.

The foregoing disclosure is the best mode devised by the inventor for practicing this invention. It is apparent, however, that methods incorporating modifications and variations will be obvious to one skilled in the art of motor vehicle clutches and lubrication thereof. Inasmuch as the foregoing disclosure is intended to enable one skilled in the pertinent art to practice the instant invention, it should not be construed to be limited thereby but should be construed to include such aforementioned obvious variations and be limited only by the spirit and scope of the following claims.

I claim:

1. A lubrication arrangement for a manual motor vehicle clutch comprising, in combination,
a release bearing disposed for axial movement along a transmission input shaft, said release bearing defining a first circumferential channel,
a release fork having spaced apart arms received within said first circumferential channel, and
means for providing lubrication at an interface between said release fork arms and said circular channel of said release bearing.

2. The clutch lubrication arrangement of claim 1 wherein said lubrication means includes oil impregnated inserts disposed in said first circumferential channel.

3. The clutch lubrication arrangement of claim 1 wherein said lubricant means include a plurality of lubricant filled, second circumferential channels formed in said release bearing adjacent said first circumferential channel.

4. The clutch lubrication arrangement of claim 1 wherein said lubricant means includes a plurality of second circumferential channels smaller than said first circumferential channel, formed in said first circumferential channel and adapted to be filled with a lubricant.

5. The clutch lubrication arrangement of claim 4 further including at least one grease fitting in communication with at least one of said second circumferential channels.

6. The clutch lubrication arrangement of claim 1 wherein said lubrication means includes a plurality of passageways terminating at ends of said release fork arms and at least one grease fitting communicating with said passageways.

7. The clutch lubrication arrangement of claim 1 wherein said lubrication means includes a flexible boot disposed on an end of said release fork arm for retaining lubricant thereabout.

8. A lubrication arrangement for a manual motor vehicle clutch comprising, in combination,
a release bearing disposed for axial translation along an input shaft, said release bearing defining a first circumferential channel,
a release fork having a pair of spaced apart arms received within said circumferential channel, and
means for providing lubrication to a region between said release fork arms and said circular channel of said release bearing.

9. The clutch lubrication arrangement of claim 8 wherein said lubrication means includes oil impregnated inserts disposed in said first circumferential channel.

10. The clutch lubrication arrangement of claim 8 wherein said lubricant means include a plurality of lubricant filled, circumferential channels formed in said first circumferential channel.

11. The clutch lubrication arrangement of claim 8 wherein a plurality of second circumferential channels smaller than said first circumferential channel formed in said first circumferential channel.

12. The clutch lubrication arrangement of claim 11 further including at least one grease fitting in communication with at least one second circumferential channel.

13. The clutch lubrication arrangement of claim 8 wherein said lubrication means includes a plurality of passageways in said release fork terminating at ends of said release fork arms and at least one grease fitting communicating with said passageways.

14. The clutch lubrication arrangement of claim 8 wherein said lubrication means includes a flexible boot disposed on an end of said release fork arm for retaining lubricant thereabout.

15. A lubrication arrangement for a manual motor vehicle clutch comprising, in combination,
a release bearing disposed for axial translation along an input shaft, said release bearing defining a channel,
a release fork having a pair of spaced apart arms received within said channel, and
means for providing lubrication to a region between said release fork arms and said channel of said release bearing.

16. The clutch lubrication arrangement of claim 15 wherein said lubrication means comprises lubricant impregnated inserts disposed in said channel.

17. The clutch lubrication arrangement of claim 15 wherein said channel defines at least one wall and said lubrication means comprises at least one groove in said wall of said channel adapted to be filled with lubricant.

18. The clutch lubrication arrangement of claim 17 wherein said lubrication means includes a grease fitting and a passageway in said release fork communicating between said grease fitting and said groove.

19. The clutch lubrication arrangement of claim 15 wherein said lubrication means includes a plurality of passageways in said release fork terminating at ends of said release fork arms and at least one grease fitting communicating with said plurality of passageways.

20. The clutch lubrication arrangement of claim 15 wherein said lubrication means includes a flexible boot disposed over an end of said release fork for retaining a lubricant thereabout.
